(19) United States
(12) Patent Application Publication
(10) Pub. No.: US 2015/0319099 A1
(43) Pub. Date: Nov. 5, 2015

(54) STORAGE AREA NETWORK SYSTEM, CONTROLLER, ACCESS CONTROL METHOD AND PROGRAM

(71) Applicant: NEC CORPORATION, Minato-ku, Tokyo (JP)

(72) Inventors: Junichi YAMATO, Tokyo (JP); Yoshihiro HASEBE, Tokyo (JP)

(73) Assignee: NEC CORPORATION, Tokyo (JP)

(21) Appl. No.: 14/647,210

(22) PCT Filed: Nov. 26, 2013
(86) PCT No.: PCT/JP2013/081734

§ 371 Date: May 26, 2015

(30) Foreign Application Priority Data
Nov. 27, 2012 (JP) 2012-258405

(51) Int. Cl. H04L 12/911; H04L 12/931; H04L 29/08

(52) U.S. Cl. CPC H04L 47/70; H04L 67/1097; H04L 49/357

(57) ABSTRACT

A storage area network system includes a storage apparatus, a plurality of hosts, a switch arranged between the storage apparatus and the hosts, a controller and an access control apparatus. The controller sets the control information in the switch so as to control the communication between the hosts and the storage apparatus, and the access control apparatus provides the controller with information on whether or not accessing between the hosts and the storage apparatus is allowable. The controller sets, in the switch, the control information corresponding to an access accept/deny that is delivered by the access control apparatus.

### CROSS REFERENCE TO RELATED APPLICATIONS

This application is a National Stage of International Application No. PCT/JP2013/081734, filed Nov. 26, 2013, claiming priority based on Japanese Patent Application No. 2012-258405, filed Nov. 27, 2012, the contents of all of which are incorporated herein by reference in their entirety. This invention relates to a storage area network system, a controller, an access control method and a program. More particularly, it relates to a storage area network system, a controller, an access control method and a program, in which a plurality of hosts shares a storage apparatus(es).

### TECHNICAL FIELD

### Background

As the storage area network system, referred to below as ‘SAN’, there are known an FC-SAN, employing a fiber channel, referred to below as ‘FC’, and an IP-SAN, employing the IP (Internet Protocol).

It is customary that, in both the FC-SAN and the IP-SAN, a plurality of hosts share one or more storage apparatuses. In the FC-SAN, a technique known as zoning may be used to limit the specific storage apparatus(es) that can be accessed from a certain given host. However, in the FC-SAN, FC switches or FC networks can be installed only at elevated costs, while the specialized knowledge proper to the fiber channel is necessary for operation as well as management.

The IP-SAN has an advantage that an Ethernet (Registered Trademark) switch may be used in place of an expensive FC switch and hence the operation as well as the management may be facilitated. Moreover, in the IP-SAN, the zoning in the FC-SAN is carried out for the VLAN (Virtual Local Area Network).

In Patent Literature 1, there is disclosed a computer system having a network for businesses constructed using the above mentioned FC-SAN or IP-SAN (FIG. 1, paragraph 19).

In Non-Patent Literatures 1, 2, the technique termed ‘OpenFlow’ is proposed. The OpenFlow comprehends the communication as end-to-end flow and performs path control, recovery from failures, load balancing and optimization on the flow-by-flow basis. An OpenFlow switch, specified in Non-Patent Literature 2, includes a secure channel for communication with an OpenFlow controller, and is run in accordance with a flow table to which supplementation or modification is instructed from time to time from the OpenFlow controller. In the flow table, a set of match conditions (Match Fields) for collation against a packet header, flow statistics information (Counters) and instructions defining the processing contents, is defined from one flow to the next. See ‘4.1 Flow Table’ of Non-Patent Literature 2.

For example, on receipt of a packet, the OpenFlow switch searches, from its flow table, such an entry having the match conditions conforming to the header information of the received packet. See ‘4.3 Match Fields’ of Non-Patent Literature 2. If, as a result of the search, the entry conforming to the received packet is found, the OpenFlow switch updates the flow statistics information (Counters), while executing the contents for processing the received packet stated in the instruction field of the entry, such as transmitting the packet out a specified port, flooding or dropping. If, as a result of the search, no entry conforming to the received packet is found, the OpenFlow switch sends a request for entry setting, that is, a request to transmit the control information to process the received packet (Packet-In message) to the OpenFlow controller over the secure channel. The OpenFlow switch receives the flow entry, having determined processing contents, so as to update the flow table. The OpenFlow switch thus uses the entry, stored in the flow table, as the control information in order to forward the packet.

In Patent Literature 2, there is disclosed a power saving system in a configuration including the above mentioned OpenFlow controller and OpenFlow switches. In the power saving system, a virtual machine(s) operating on a server within a rack is migrated to another server, based on a service load of the virtual machine(s), and the server where the virtual machine(s) has ceased to exist is set to a non-operating state, thereby saving the power consumption. In paragraph [0032] of Patent Literature 2, it is stated that the storage or the storage apparatus within the rack can be replaced by a DAS (Direct Attached Storage) or by the above mentioned FC-SAN or IP-SAN.
Patent Literature 1:
JP Patent Kokai Publication No. JP2011-141609A
Patent Literature 2:
JP Patent Kokai Publication No. JP2011-82799A

### NON-PATENT LITERATURE

Non-Patent Literature 1:
Nick McKeown and seven others: “OpenFlow: Enabling Innovation in Campus Networks”, [online], [searched in Heisei24 (2012), October 24], Internet
<URL:http://www.openflow.org/documents/openflow-wp-latest.pdf>
Non-Patent Literature 2:
“OpenFlow Switch Specification” Version 1.1.0 Implemented (Wire Protocol 0x02), [online], [searched in Heisei24 (2012), October 24], Internet
<URL:http://www.openflow.org/documents/openflow-spec-v1.1.0pdf>

### SUMMARY

The following analysis is given by the present invention. As described above, the FC-SAN, completed as a technique per se, can hardly be adopted in configurations including larger numbers of hosts or channels, because of elevated costs in laying switches or channels.

On the other hand, in the IP-SAN, in which laying costs are lower, it is necessary to take separate measures in connection with exclusive control involved in using the zoning with VLAN. In particular, in a configuration in which a plurality of hosts share one or more storage apparatuses, it is necessary to strictly limit accessing to the storage apparatus(es) from the host the accessing by which inherently must be prohibited, such as the host operating under a different OS or the host that is in a standby state.

In this connection, it is merely stated in the Patent Literatures 1 and 2 that the above mentioned FC-SAN or IP-SAN may be arrayed alternatively.

It is an object of the present invention to provide a storage area network system, a controller, an access control method and a program which are able to contribute to improving the ascendancy in cost and in management as well as ease in access control proper to SAN.

In a first aspect of the present invention, there is provided a storage area network system comprising a storage apparatus(es), a plurality of hosts, a switch arranged between the storage apparatus(es) and the hosts, a controller that sets control information in the switch so as to control communication between the hosts and the storage apparatus(es), and an access control apparatus that provides the switch with information on whether or not accessing between the hosts and the storage apparatus(es) is allowable. The controller sets in the switch the control information corresponding to the information on an access accept/deny that is delivered from the access control apparatus.

In a second aspect of the present invention, there is provided a controller comprising a switch control section that sets control information in a switch arranged between a storage apparatus(es) and a plurality of hosts, together forming a storage area network, so as to control communication between the storage apparatus(es) and the hosts. The control information that is set by the switch control section corresponds to an access accept/deny delivered from an access control apparatus which provides information on whether or not accessing between the hosts and the storage apparatus(es) is allowable.

In a third aspect of the present invention, there is provided an access controlling method in a storage area network system comprising a storage apparatus(es), a plurality of hosts, a switch arranged between the storage apparatus(es) and the hosts, a controller that sets control information in the switch so as to control communication between the hosts and the storage apparatus(es), and an access control apparatus that holds information on whether or not accessing between the hosts and the storage apparatus(es) is allowable. The method comprises acquiring, from the access control apparatus, the information indicating whether or not accessing between the hosts and the storage apparatus(es) is allowable, and setting, in the switch, the control information corresponding to the information on an access accept/deny that is delivered from the access control apparatus. The present method is bound up with a particular machine which is the storage area network system.

In a fourth aspect of the present invention, there is provided a program that causes a computer which forms a controller arranged in a storage area network system comprising, in addition to the controller, a storage apparatus(es), a plurality of hosts, a switch arranged between the storage apparatus(es) and the hosts, and an access control apparatus that delivers to the controller information on whether or not accessing between the hosts and the storage apparatus(es) is allowable, the controller setting the control information in the switch to control communication between the hosts and the storage apparatus(es), to perform processing of acquiring, from the access control apparatus, the information indicating whether or not accessing between the hosts and the storage apparatus(es) is allowable, and processing of setting, in the switch, the control information corresponding to an access accept/deny that is delivered from the access control apparatus. It is noted that the program can be recorded on a computer-readable (non-transient) recording medium. That is, the present invention may be implemented as a computer program product.

According to the present invention, it is possible to contribute to improving the ascendancy of the above mentioned SAN as to costs and operation and the ease in access control.

### BRIEF DESCRIPTION OF THE DRAWINGS

FIG. 1 is a block diagram showing a configuration of an exemplary embodiment.

FIG. 2 is a block diagram showing a configuration of a storage area network system according to an exemplary embodiment 1.

FIG. 3 is a block diagram showing a detailed configuration of a switch according to the exemplary embodiment 1.

FIG. 4 is a diagrammatic view showing example control information (flow entry) set in a switch of the exemplary embodiment 1.

FIG. 5 is a diagrammatic view showing processing contents (Actions) set in an instruction field (Instructions) of the switch of the exemplary embodiment 1.

FIG. 6 is a block diagram showing a detailed configuration of a controller of the exemplary embodiment 1.

FIGS. 7(a) and 7(b) are diagrammatic views showing example topology information retained by the controller of the exemplary embodiment 1.

FIG. 8 is a diagrammatic view showing example path information retained by the controller of the exemplary embodiment 1.

FIG. 9 is a block diagram showing a detailed configuration of an access control apparatus of the exemplary embodiment 1.

FIG. 10 is a diagrammatic view showing example access control information (host group information) retained by the access control apparatus of the exemplary embodiment 1.

FIG. 11 is a diagrammatic view showing example access control information (storage group information) retained by the access control apparatus of the exemplary embodiment 1.

FIG. 12 is a sequence diagram showing the operation at the time of access permission of the storage area network system according to the exemplary embodiment 1.

FIG. 13 is a sequence diagram showing the operation at the time of access prohibition of the storage area network system according to the exemplary embodiment 1.

FIG. 14 is a sequence diagram showing the operation at the time of host change of the storage area network system according to the exemplary embodiment 1.

FIG. 15 is a flowchart showing the operation of the switch of the exemplary embodiment 1.

FIG. 16 is a flowchart showing the operation of the controller of the exemplary embodiment 1 at the time of receipt of a control information setting request.

FIG. 17 is a flowchart showing the operation of the controller of the exemplary embodiment 1 at the time of receipt of a notification of change of an active host from the access control apparatus.

FIG. 18 is a flowchart showing the operation of the controller of an exemplary embodiment 2 at the time of receipt of a control information setting request.

FIG. 19 is a flowchart showing the operation of the controller of an exemplary embodiment 3 at the time of receipt of a notification of change of an active host from the access control apparatus.

FIG. 20 is a flowchart showing the operation of the controller of the exemplary embodiment 4 at the time of receipt of a notification of change of an active host from the access control apparatus.

FIG. 21 is a block diagram showing a configuration of a storage area network system according to an exemplary embodiment 5.

FIG. 22 is a block diagram showing a configuration of a storage area network system according to an exemplary embodiment 6.

### PREFERRED MODES

A summary of a preferred exemplary embodiment of the present invention will now be described with reference to the drawings. It is noted that symbols as used in the following summary are attached to respective associated elements only as examples to assist in understanding and are not intended to limit the present invention to the mode illustrated.

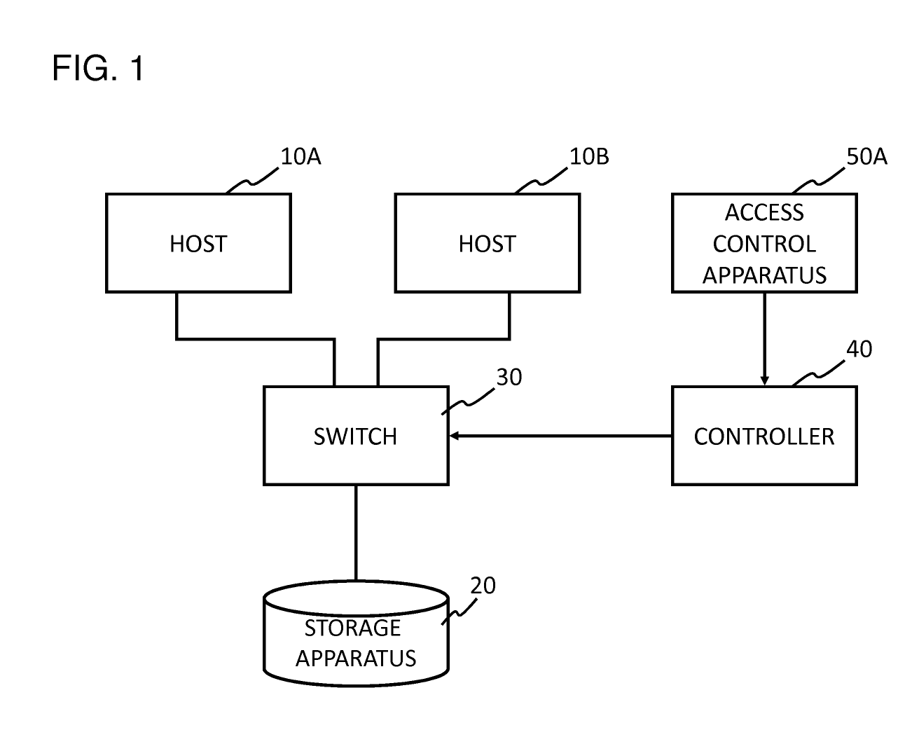

Referring to FIG. 1, an exemplary embodiment is implemented by a configuration comprised of a storage apparatus 20, a plurality of hosts 10A, 10B, a switch 30 arranged between the storage apparatus and the hosts, a controller 40 and an access control apparatus 50A. The controller sets control information in the switch 30 so as to control the communication between the host and the storage apparatus, while the access control apparatus delivers to the controller 40 the information on whether or not accessing between the hosts and the storage apparatus is allowable.

More specifically, the controller 40 sets, in the switch 30, the control information corresponding to an access accept/deny that is delivered from the access control apparatus 50A. If the access control apparatus 50A delivers the information pertinent to the zoning to the controller 40, access control pertinent to the zoning is executed. If the access control apparatus 50A delivers the information pertinent to fencing of blocking the accessing from a certain host, access control pertinent to the fencing is executed.

According to the subject exemplary embodiment, a storage area network may be constructed using the switch controlled by the controller typified by the OpenFlow switch, as described above. Moreover, since the access control apparatus manages whether or not accessing is allowable, access control between the host(s) and the storage apparatus(es) may be realized without using VLAN etc. Of course, it is also possible to use VLAN to discriminate the packet destined from a certain host to a certain storage apparatus.

### EXEMPLARY EMBODIMENT 1

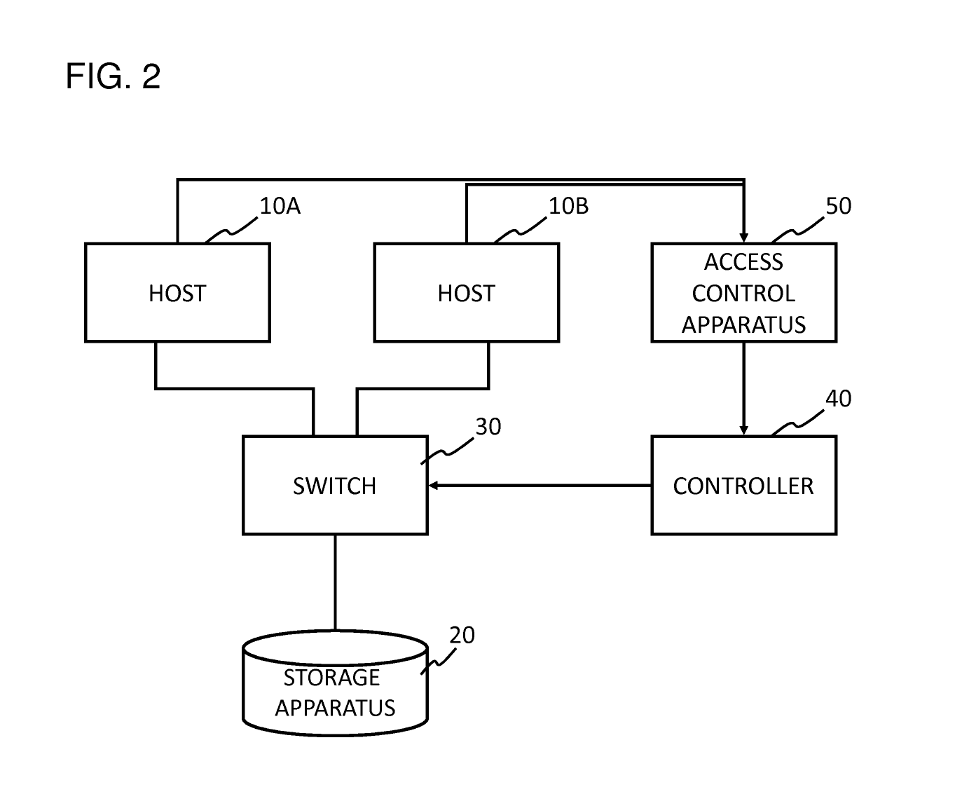

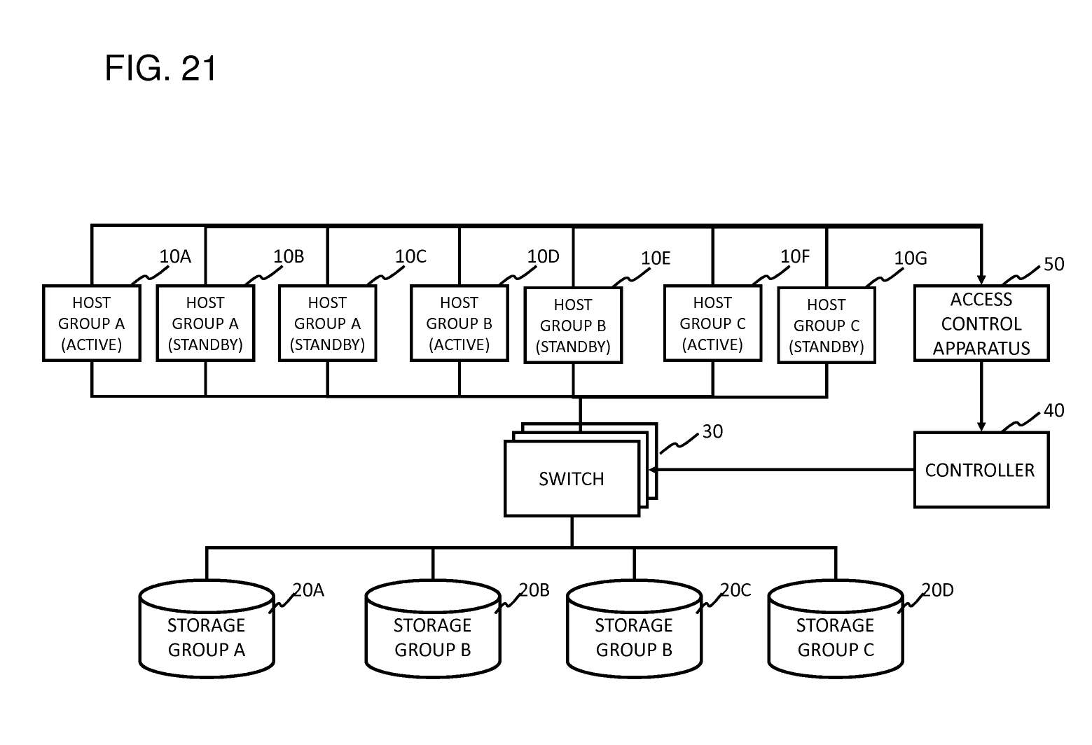

An exemplary embodiment 1 will now be explained in detail with reference to the drawings. FIG. 2 depicts a block diagram showing a configuration of a storage area network system according to the exemplary embodiment 1. Referring to FIG. 2, there is shown a configuration including two hosts 10A, 10B, a storage apparatus(es) 20, a switch(es) 30, a controller 40 and an access control apparatus 50. It is noted that the numbers of the hosts, storage apparatus and the switch are merely illustrative and such a configuration in which a plurality of switches are arranged between larger numbers of hosts and storage apparatuses, as shown for example in FIG. 21, may also be used.

The hosts 10A, 10B are computers, such as servers, accessing the storage apparatus(es) in response to a request from a client, not shown, so as to render a variety of services.

The storage apparatus 20 is a memory, such as a magnetic disc, a non-volatile memory, a magneto-optical disc, an optical disc, or an array device thereof, capable of operating under a protocol used in IP-SAN, such as iSCSI (Internet Small Computer System Interface), iFCP (Internet Fibre Channel Protocol) or FCIP (Fibre Channel over IP).

The switch 30 is arranged between the hosts 10A, 10B and the storage apparatus 20 and relays a packet between the hosts 10A, 10B and the storage apparatus 20, using the control information as set from the controller 40. Specifically, the switch 30 holds a flow entry (flow entries), as set from the controller 40, as the control information. On receipt of the packet, the switch 30 searches the flow entries it is holding for such flow entry having match conditions conforming to the received packets, and executes packet forwarding processing, as an example. The switch 30 may, for example, be an OpenFlow switch shown in Non-Patent Literature 2.

On detection of an occurrence of communication via switch 30 from the host to the storage apparatus, the controller 40 decides, based on the information received from the access control apparatus 50, whether or not accessing from the host to the storage apparatus is allowable. The controller sets the control information (a flow entry) in the switch 30 in response to the result of the decision. Such the controller 40 may be implemented by adding, to an OpenFlow controller of the Non-Patent Literature 2, a function of preparing the control information which is in keeping with the information from the access control apparatus 50.

The access control apparatus 50 supervises the state of the hosts 10A, 10B and, each time a change has been caused, notifies the controller 40 of the content of the change. In the subject exemplary embodiment, the access control apparatus 50 supervises, as the states of the hosts 10A, 10B, whether these hosts are in an active or standby state.

In the subject exemplary embodiment, it is assumed that the hosts 10A, 10B and the access control apparatus 50 of FIG. 2 are interconnected over an Ethernet (Registered Trademark) cable or a serial cable, and that the switch 30 and the controller 40 are interconnected over a secure channel.

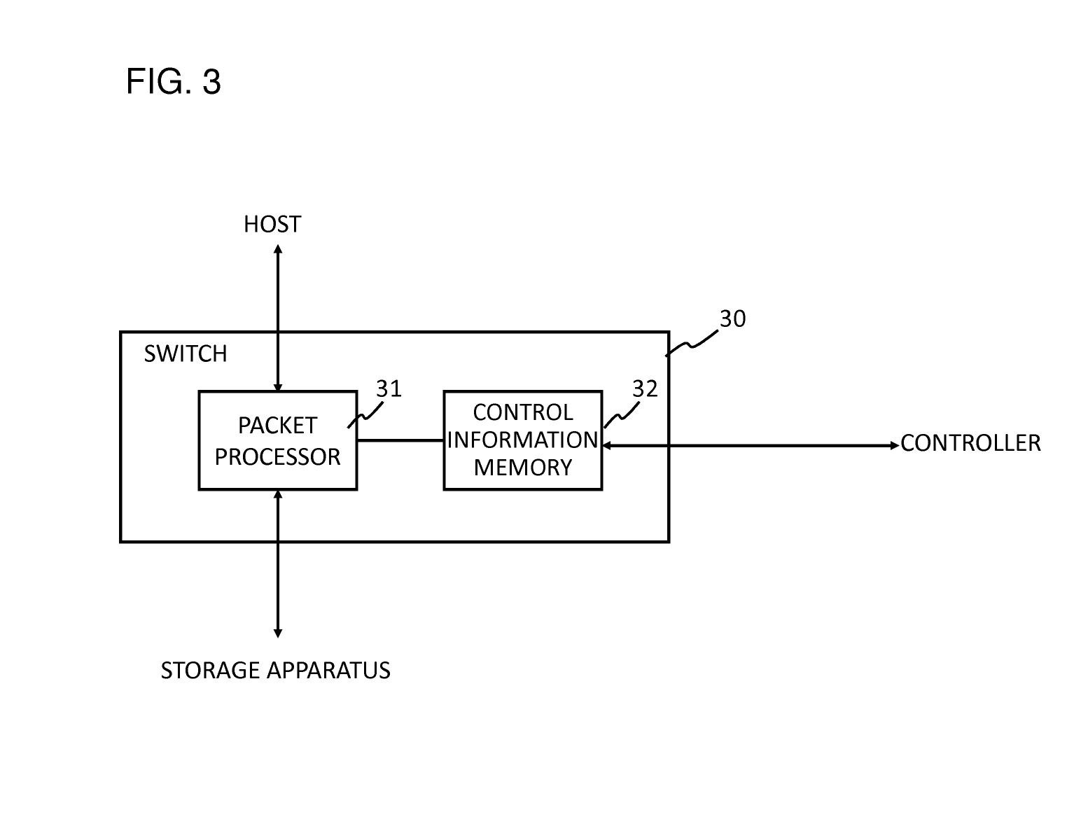

The respective devices of FIG. 2 will now be individually explained. To begin with, the configuration of the switch 30 is explained. FIG. 3 depicts a detailed block diagram of the switch of the exemplary embodiment 1. Referring to FIG. 3, the switch 30 includes a packet processor 31 and a control information memory 32 constituted by e.g., an associative memory that holds the control information as set from the controller 40.

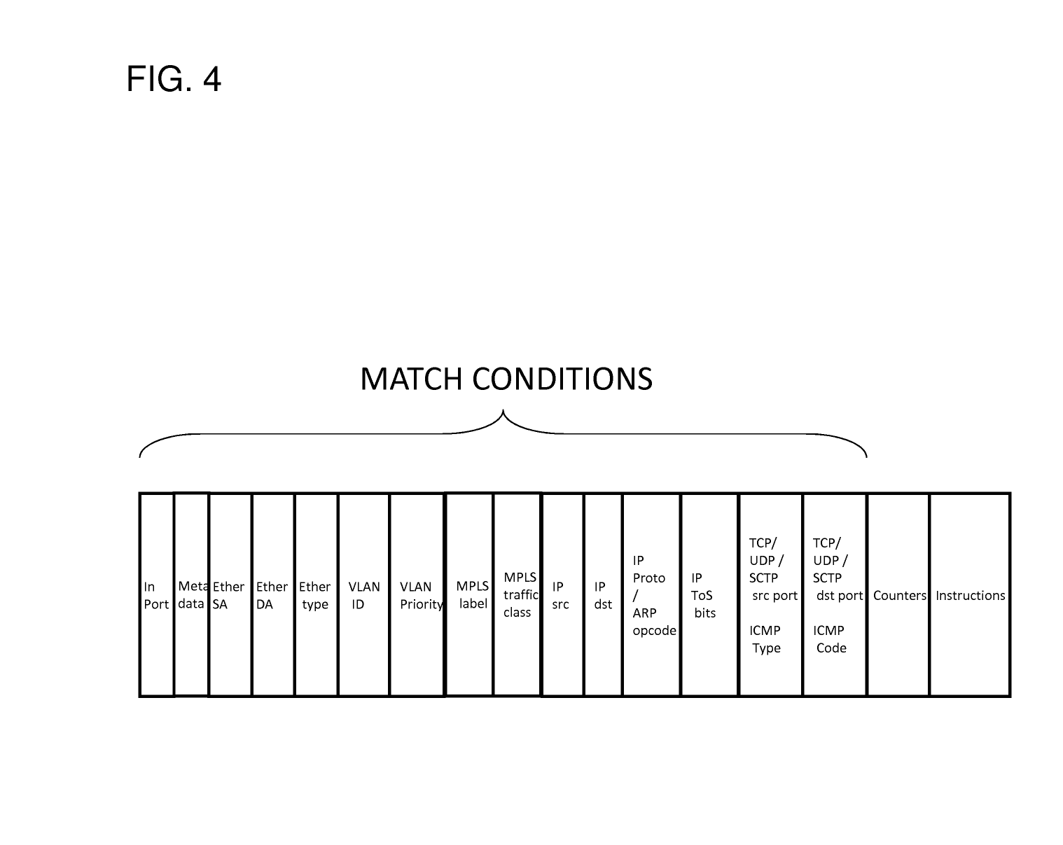

FIG. 4 depicts example control information (flow entry) retained by the control information memory 32 of the switch 30. The flow entry, shown FIG. 4, includes a plurality of fields in which to store match conditions for collation against a packet header or the like of the packet(s) received. The flow entry also includes a field for the flow statistics information (Counters) in which to store the statistics information for those packets that conform to the matching conditions, and an instruction field (Instructions) in which to store contents of processing (Actions) to be applied to the packet(s) conforming to the matching conditions. It is possible to set wildcards as the matching conditions.

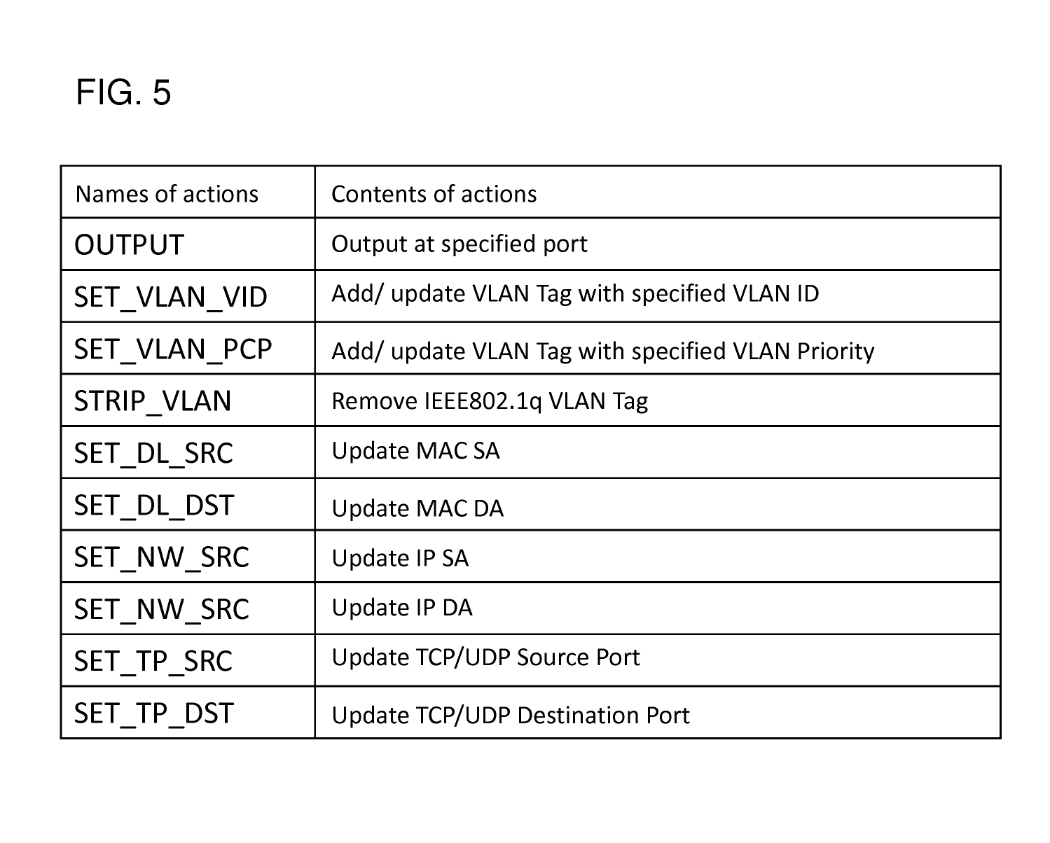

FIG. 5 shows example processing contents (actions) that can be set in the instruction field (Instructions) of the control information (flow entry). Specifically, ‘OUTPUT’ denotes an action to output the packet received out a specified port (interface), and SET_VLAN_VID to SET_TP_DST are actions that correct the field(s) of the packet header. These actions may be optionally combined to render it possible to modify VLAN ID of a packet, destined from a source of communication to a destination of communication, so as to output the resulting packet out a port specified. In case no action is set in the instruction field (Instructions), the packet is dropped.

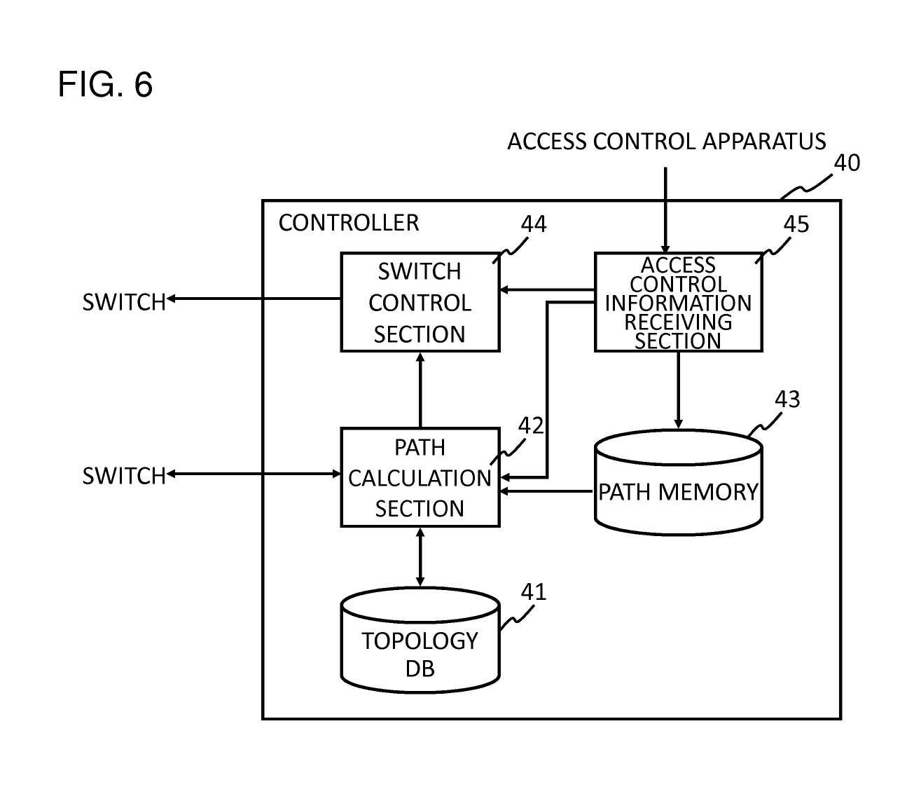

The configuration of the controller 40 will now be explained with reference to the drawings. FIG. 6 depicts a block diagram showing the detailed configuration of the controller of the exemplary embodiment 1. Referring to FIG. 6, the controller 40 includes a topology database (topology DB) 41, a path calculation section 42, a path memory 43, a switch control section 44 and an access control information receiving section 45.

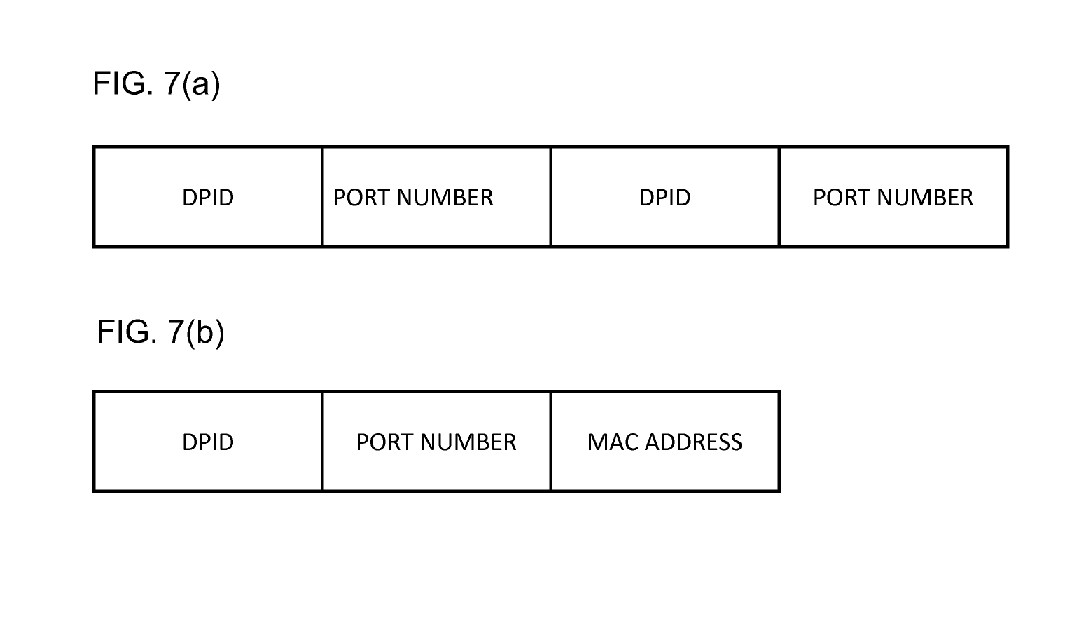

The topology DB 41 is a database that manages the relationship of interconnections among the switch, hosts, the storage apparatus and so forth. FIG. 7(a) and FIG. 7 (b) depict example entries as retained by the topology DB 41. Specifically, in FIG. 7(a), in which there are shown entries illustrating the relationship of interconnections among the switches, ‘DPID’ (DataPath IDentifier) denotes an identifier for each switch and the ‘port number’ the number of a port connecting to a peer switch. The relationship of interconnections among the switches can be managed in this manner in terms of DPID-port number pairs. In FIG. 7(b), there are shown entries illustrating the relationship of interconnections among the switch, hosts and the storage apparatus(es). In this case, the DPIDs and the port numbers of the switches can be managed in association with MAC (Media Access Control) addresses of the hosts or the storage apparatus(es).

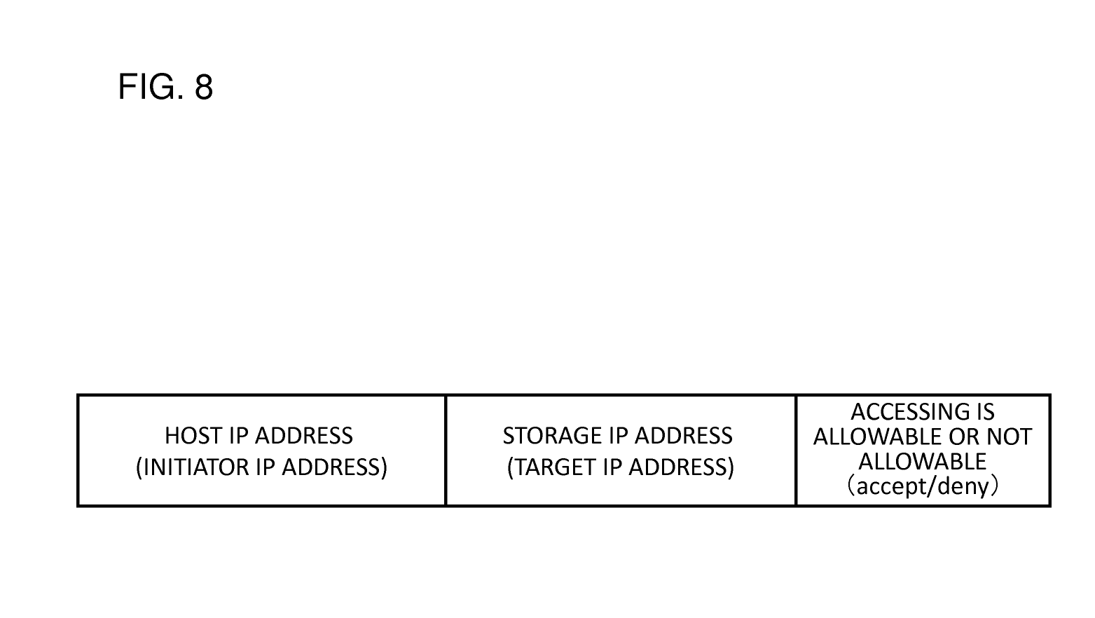

The path memory 43 is constituted by, for example, a table in which there is recorded whether or not a path can be set between an optional host and an optional storage apparatus(es). FIG. 8 shows example path information retained by the path memory 43. In the example shown in FIG. 8, it is possible to set whether or not to allow accessing (accept/deny) between a host IP address (initiator IP address) and a storage IP address (target IP address).

On receipt of a request for setting the control information from the switch 30 or a notification for host exchange from the access control apparatus, the path calculation section 42 first decides, by referencing the path memory 43, whether or not the storage apparatus can be accessed from the host of interest. If it is decided that the accessing is possible, that is, the communication is allowable, the path calculation section 42 references the topology DB 41 to compute the packet forwarding path between the host and the storage apparatus specified. In addition, the path calculation section 42 of the subject exemplary embodiment collects the topology information from the switch 30 for reflection thereof in the topology DB 41. For collection of the topology information from the switch 30, a variety of routing protocols, such as LLDP (Link Layer Discovery Protocol) or OSPF (Open Shortest Path First), may be used as collection techniques.

The switch control section 44 prepares and sets the control information (flow entry) in the switch 30 in order to allow the switch to forward the packet along the path calculated by the path calculation section 42.

Based on the information received from the access control apparatus 50, the access control information receiving section 45 decides whether or not it is possible to set a path between the host and the storage apparatus, and updates the contents of the path memory 43.

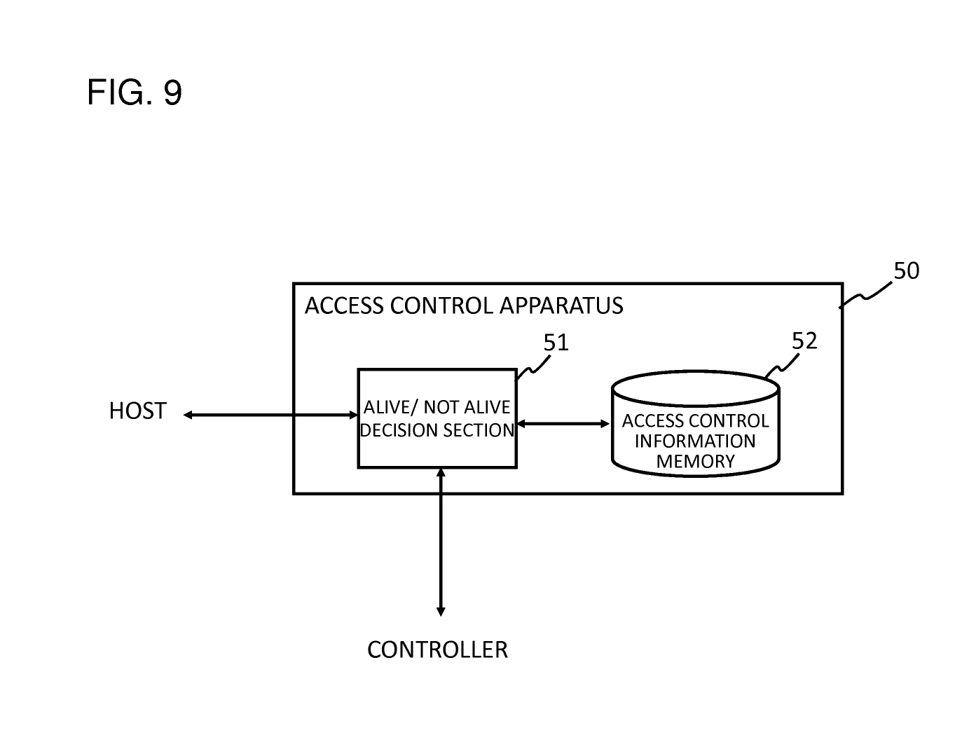

The configuration of the access control apparatus 50 will now be explained with reference to the drawings. FIG. 9 depicts a block diagram showing a detailed configuration of the access control apparatus of the exemplary embodiment 1. Referring to FIG. 9, the access control apparatus 50 includes an alive/not alive decision section 51 and an access control information memory 52.

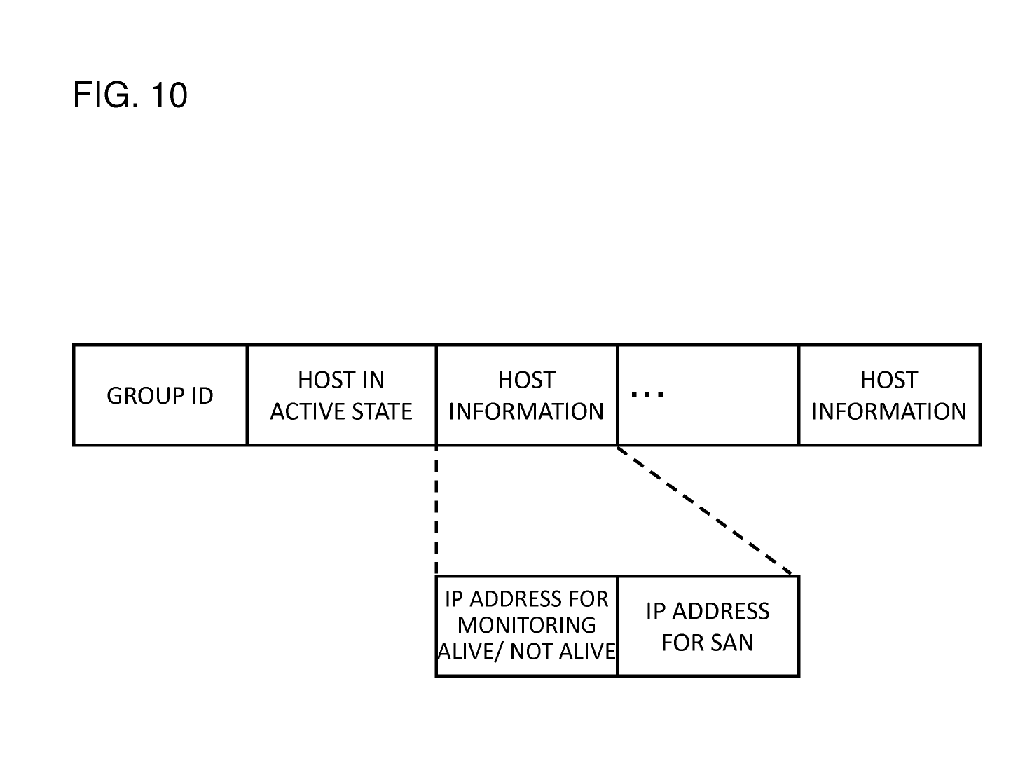

The access control information memory 52 stores groups of hosts and a storage apparatus(es) that can be accessed by each group of hosts. FIG. 10 shows example access control information, more specifically, the host group information, retained by the access control information memory. A group ID is an identifier for a group sharing one or more storage apparatuses. The hosts in active state denote such hosts that are currently in active state. The information on the hosts (host information) indicates the hosts belonging to the group of hosts as specified by the group identifier. The information on each individual host includes an IP address for alive/not alive monitoring, that is, an IP address used for monitoring whether or not a host in question is alive, and an IP address for SAN of the host which is an IP address on the storage area network side. Each host in active state is expressed by, for example, a numerical figure indicating which number host in the host information is active, an IP address for monitoring whether or not the host in question is alive, and by an IP address for SAN of the host of interest.

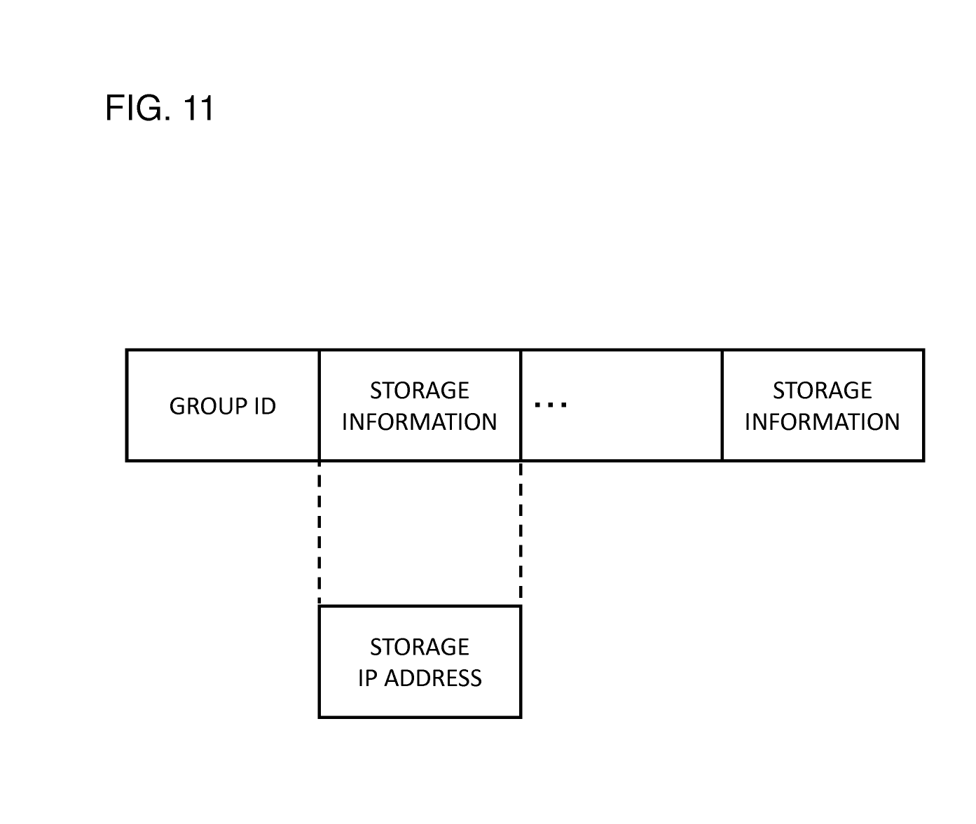

FIG. 11 shows example access control information, more specifically, the storage group information, as retained by the access control information memory 52. In the example of FIG. 11, the access control information is made up of a group identifier (group ID) corresponding to the group ID of the above mentioned host group, and the information on the storage apparatus(es) belonging to the same group, viz., one or more storage apparatus(es) that can be accessed by the hosts having the group ID. It is noted that, as the information on the storage apparatuses, an IP address of the storage apparatuses 20 used at the time of connection thereof to the hosts 10A, 10B (IP address of the storage apparatus) is used.

The alive/not alive decision section 51 monitors the states of the hosts 10A, 10B to control the hosts so that one host will be in active state in each group of hosts at any time. Also, on detection of changes in the host states, the alive/not alive decision section 51 updates the contents of the access control information memory 52. Moreover, based on the above mentioned contents of the access control information memory 52, the alive/not alive decision section 51 indexes out whether or not accessing between the host(s) and the storage apparatus(es) is possible, and notifies the result to the controller 40. In the subject exemplary embodiment, just one of the hosts of the same group of hosts which is in the active state is decided to be capable of accessing, that is, accepting, the storage apparatus to which the same group ID as that of the one host has been set. On the other hand, accessing between the host and the storage apparatus belonging to groups different from each other or that from the host that belongs to the same group as that of the storage apparatus but that is in the standby state is decided to be denied.

It is noted that an initial value of the access control information memory 52 may be set by e.g., a network administrator such as at the time of booting the present system. An initial value of the path memory 43 of the controller 40 may also be set at the same time by the network administrator. Or, the contents of the access control information memory 52 may be notified by the access control apparatus 50 to the controller 40 by way of performing an initializing operation.

Among methods for alive/not alive monitoring of the hosts 10A, 10B by the alive/not alive decision section 51, there is such a method in which the hosts 10A, 10B periodically send packets notifying the access control apparatus 50 of liveness of the hosts. Such a method may also be used in which the access control apparatus 50 sends packets notifying the hosts 10A, 10B of their liveness and in which the hosts 10A, 10B respond to the packets. Or, a variety of methods used in an HA (High Availability) cluster may be used to achieve the same results.

It is noted that respective parts (processing means) of the controller 40 as well as the access control apparatus 50 shown in FIG. 6 and FIG. 9 may be implemented by a computer program that causes a computer constituting the controller or the access control apparatus to execute the above mentioned processing with the use of the computer's hardware.

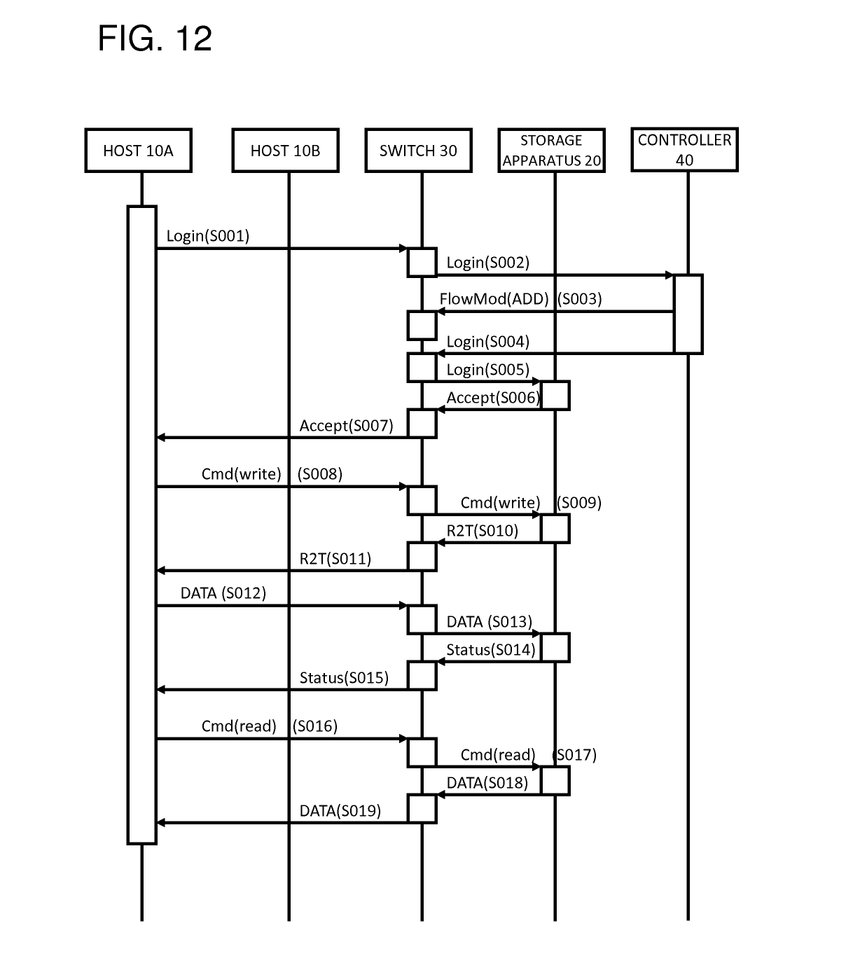

The operation of the subject exemplary embodiment will now be explained in detail with reference to the drawings. FIG. 12 shows the operation for a case where the hosts 10A, 10B as well as the storage apparatus 20 belong to the same group and an accessing is made from the host 10A in the active state to the storage apparatus 20. In this case, a log-in request made from the host 10A (step S001) is sent to the controller 40 (step S002). The controller 40 references the topology DB 41 and the path memory 43 to set the control information that causes a packet to be forwarded from the host 10A to the storage apparatus (flow entry) in the switch 30 (step S003).

After setting the control information (flow entry), the controller 40 outputs (step S004) to the switch 30 the log-in request packet received by the controller 40 at the step S002. Packets are then exchanged at steps S006 to S019 between the host 10A and the storage apparatus 20 in accordance with the control information (flow entry) as set in the step S003.

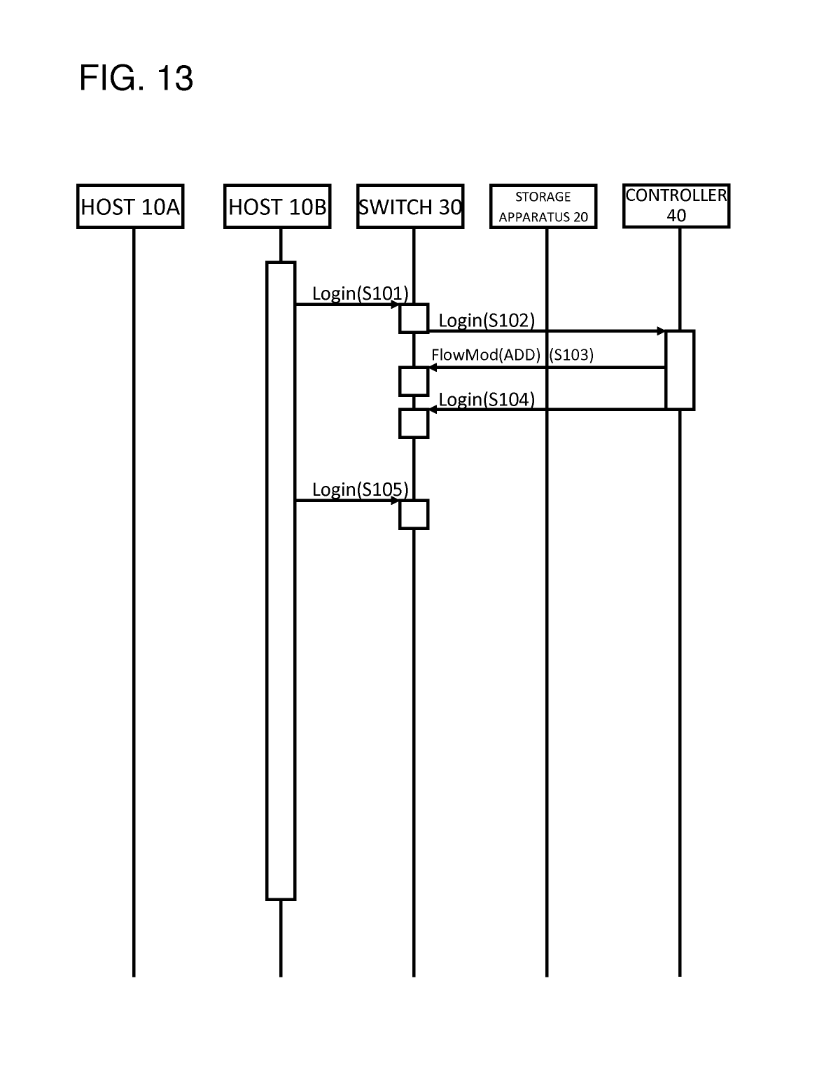

FIG. 13 shows the operation in case the hosts 10A, 10B and the storage apparatus 20 belong to the same group but accessing is made to the storage apparatus 20 from the host 10B which is in the standby state. Again in this case, a log-in request made from the host 10B (step S101) is forwarded to the controller 40 (step S102). However, the controller 40 references the topology DB 41 and the path memory 43 and decides that an access from the host 10B to the storage apparatus 20 is prohibited. The controller thus sets, in the switch 30, the control information (flow entry) instructing dropping the packet originating from the host 10B (step S103).

After setting the control information (flow entry), the controller 40 outputs a log-in request packet, received in the step S102, to the switch 30 (step S104). The switch 30 then drops the log-in request packet from the host 10B in accordance with the control information (flow entry) as set in the step S103. From that time on, even if a log-in request packet(s) should be sent from the host 10B, the switch 30 continues dropping the log-in request packet(s) thus sent from the host 10B (step S105). It is noted that the control information for dropping the packet(s) (flow entry) is retained in the switch 30 until a preset time out or until the host 10B is turned into active state.

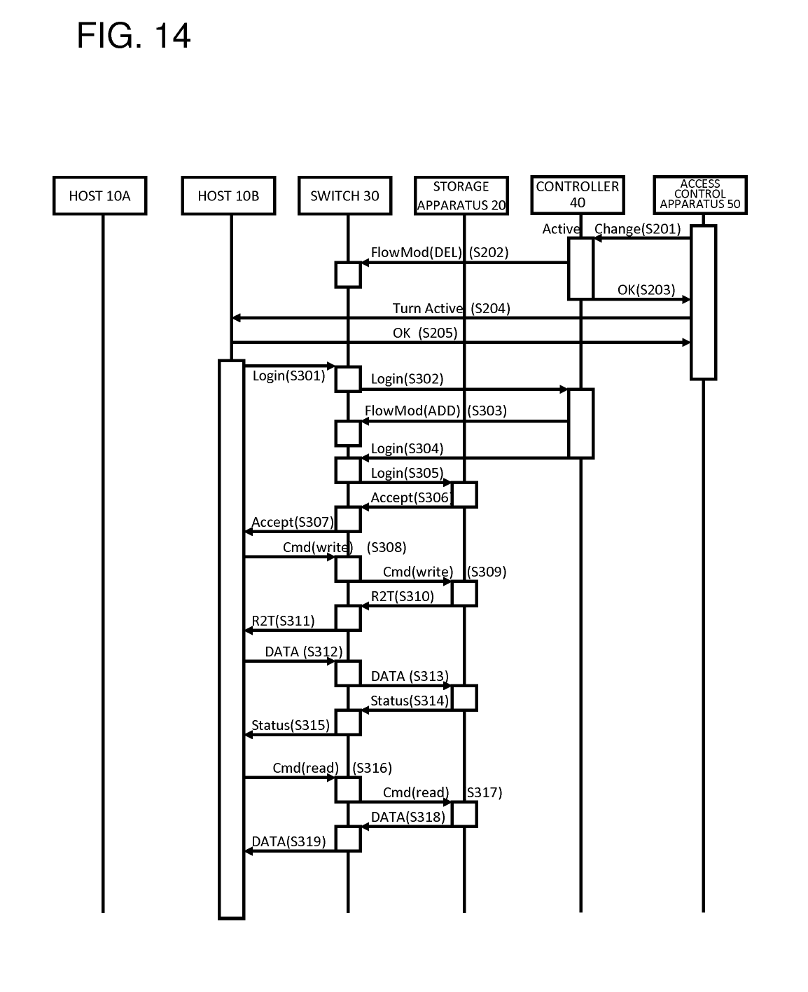

FIG. 14 shows the operation in case the host 10A has failed. On detection of occurrence of failure in the host 10A, the access control apparatus 50 in a step S201 notifies the controller 40 of the fact that the host 10A has turned into the standby state (Active Change). On receipt of such notification, the controller 40 deletes the control information (flow entry) that has been set in the switch 30 and that allows accessing from the host 10A to the storage apparatus 20 (FlowMod (DEL)) in a step S202. After deletion of the control information (flow entry), the controller 40 notifies the access control apparatus 50 of the completion of the deletion (OK in a step S203).

The access control apparatus 50 bootstraps the host 10B that has been in the standby state (Turn Active OK) in steps S204, S205. From that time on, accessing from the host 10B to the storage apparatus 20 is allowable (steps S301 to S319) as shown in FIG. 12.

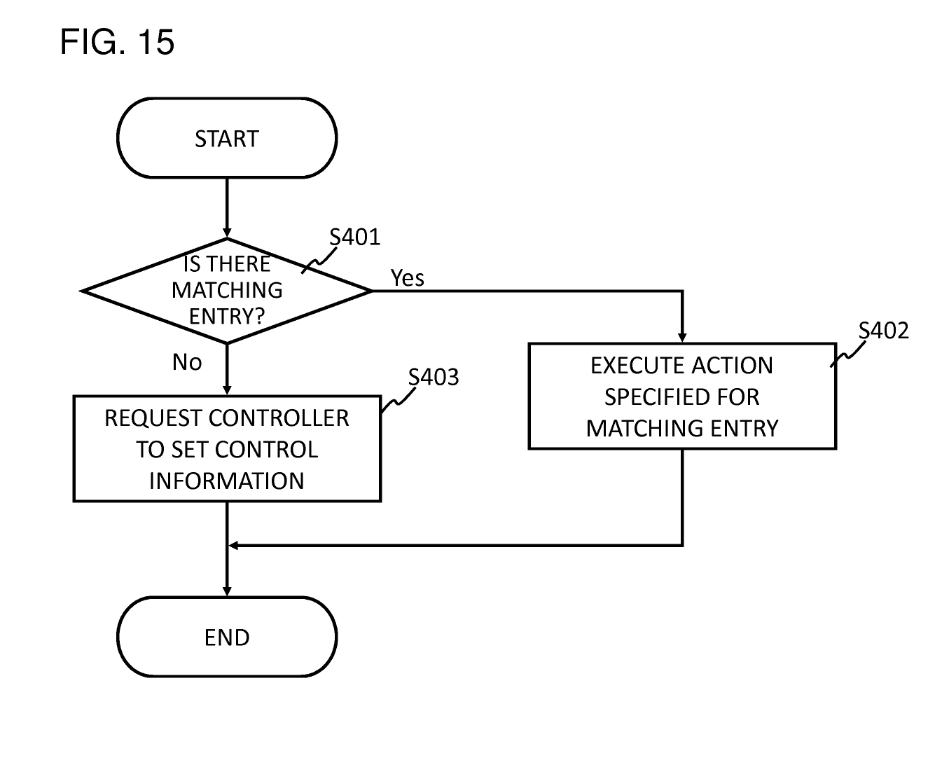

Next, detailed operations in the respective apparatuses shown in FIG. 12 through to FIG. 14 will be individually explained. FIG. 15 depicts a flowchart showing the basic operation of the switch 30 in the exemplary embodiment 1.

On receipt of a packet in the packet processor 31, the switch 30 searches for an entry, having match conditions conforming to the received packet, from the control information memory 32 (step S401).

If, as a result of the search, such entry having the match condition conforming to the received packet has been found, the packet processor 31 performs, for the received packet, such processing that is defined in the instruction field of the relevant entry (step S402).

If conversely no entry having the match conditions conforming to the received packet has been found, the packet processor 31 sends the received packet or the information, extracted from the packet, to the controller 40, and requests the controller to set the control information to process the received packet (step S403).

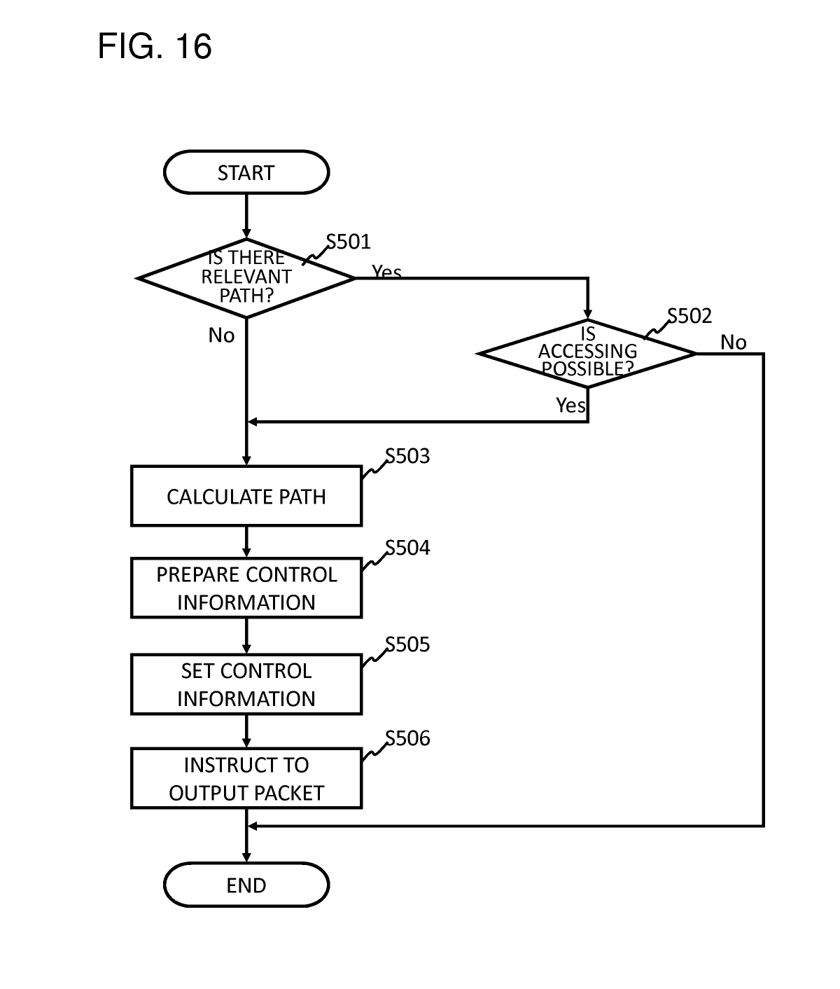

FIG. 16 depicts a flowchart showing the operation of the controller 40 of the exemplary embodiment 1 at the time of receipt of the control information setting request. On receipt of the control information setting request, described above, the controller 40 searches the path memory 43 for the combination of the transmit source IP address and the destination IP address in the header of the packet that has been received by the switch 30 and that is involved in the control information setting request (step S501). If the relevant entry has been found, the controller 40 confirms whether or not accessing from the relevant host to the storage apparatus is allowable (step S502).

If, as the result of the above, it is found that the outstanding communication is that from the IP address combination for which access prohibition (deny) is set in the path memory 43 (No in the step S502), the controller 40 discards the control information setting request.

If conversely no relevant entry is found in the path memory 43 (No of the step S501) or if the outstanding communication is that from the IP address combination for which access permission (accept) is set (Yes in the step S502), the path calculation section 42 calculates the path (step S503). By the way, path calculations may be implemented by e.g., the Dijkstra algorithm by relying upon the packet header information and the topology DB 41.

The controller 40 then prepares, in a step S504, the control information (flow entry) to be set on the switches 30 lying on the path as calculated in the step S503. For example, supposing that a packet from the host 10A of FIG. 2 is to be forwarded to the storage apparatus 20, the control information to be prepared is one in which the match condition is such that the transmit source IP address is the IP address for SAN of the host 10A and the destination IP address is the IP address of the storage apparatus and in which the action as set is for outputting the packet out a switch port connecting to the storage apparatus 20.

The controller 40 then sets, by its switch control section 44, the control information (flow entry), prepared in the step S504, in the switch 30 (step S505). Finally, the controller 40 references the network topology and instructs a near-by switch 30 to output the packet received with the control information setting request to the storage apparatus 20, as the destination, using the packet received or the information extracted from the packet (step S506). In this manner, the first packet, which triggered the control information setting request, arrives at the storage apparatus 20.

If the access control apparatus 50 has changed a host in the active state, the access control apparatus informs the controller 40 about the host that has turned from the active state to the standby state, as explained in connection with FIG. 14.

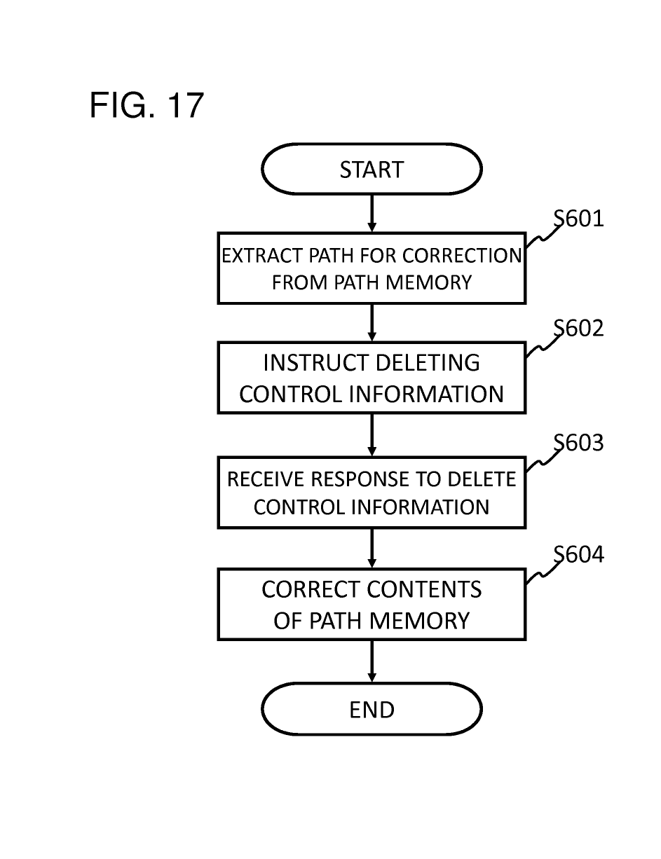

FIG. 17 depicts a flow chart illustrating the operation of the controller 40 that has received from the access control apparatus 50 a notification of change of the host in the active state.

On receipt of the notification of change of the host in the active state, the controller 40 searches the path memory 43 for the entry in which the host IP address is the IP address of the host which has now turned into the standby state, that is, the path that needs to be corrected (step S601).

The controller 40 then instructs the switch 30 to delete the control information (flow entry) in which the transmit source IP address or the destination IP address as the match conditions is coincident with the IP address of the host which has thus turned into the standby state (step S602).

On receipt in a step S603 of a response from the switch 30 that the relevant control information (flow entry) has been deleted, the controller 40 updates the content of the accept/deny field of the entry detected in the step S601 from the communication permission (accept) to the communication prohibition (deny).

If the controller has received the notification that the host has newly turned into the active state, it may search the path memory 43 for an entry in which the host IP address is the IP address of the host which has newly turned into the active state, that is, a path that needs to be corrected, in the step S601. The controller may then update, in the step S603, the content of the accept/deny field of the entry from communication prohibition (deny) to communication permission (accept).

It is noted that, in the step S603, the controller is to receive a response that the control information (flow entry) has been deleted. Alternatively, the processing of receiving the response from the switch 30 may be replaced by a processing for the controller 40 to wait for preset time duration.

In the subject exemplary embodiment, described above, it is possible, in the high availability configuration in which a host is changed over from an active state to a standby state or vice versa, to prohibit accessing to a storage apparatus from any different group as well as to prohibit accessing to a storage apparatus from a host that belongs to the same group but that is currently in the standby state. Additionally, switch setting is automatically changed in association operatively with the change of state of a host to or from an active state.

### EXEMPLARY EMBODIMENT 2

An exemplary embodiment 2 in which, at the time of receiving the control information setting request, the controller 40 sets the control information (flow entry) to drop a packet destined to be sent to a storage apparatus from a host the accessing by which is not permitted. Since the exemplary embodiments 2 to 4, hereinafter explained, may be implemented by a configuration similar to that of the exemplary embodiment 1, the following description is centered about the points of difference in operation.

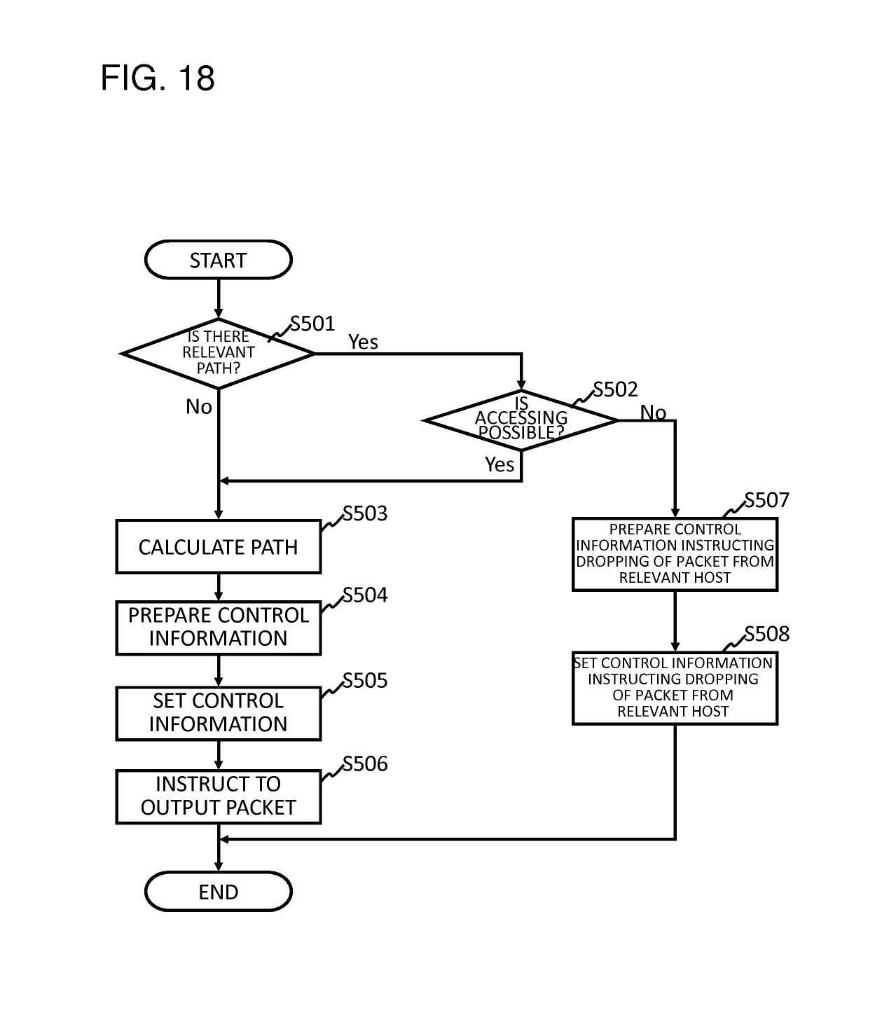

FIG. 18 depicts a flow chart showing the operation of a controller of the exemplary embodiment 2 at the time of receiving the control information setting request. The point of difference of operation of the subject exemplary embodiment from that of the exemplary embodiment 1 shown in FIG. 16 is that, if, as a result of decision in the step S502, it is found that the outstanding communication is one from the IP address combination for which access prohibition (deny) has been set in the path memory 43 (No of the step S502), the controller 40 performs the following processing:

Initially, the controller 40 prepares the control information (flow entry) instructing dropping a packet in which a transmit source IP address or a destination IP address in the match conditions thereof is an IP address of a host the accessing by which to the storage apparatus 20 is prohibited (step S507).

The controller 40 then sets, by its switch controller 44, the control information (flow entry), prepared in the step S507, in the switch 30 (step S508).

As a result, the packet from the host in the standby state is dropped by the switch 30. Doing so may render it possible to prevent that unneeded packets flow in the switch 30 until the access control apparatus 50 explicitly changes over the active host, possibly resulting in occurrences of unneeded control information setting. In addition, since the occurrences of unneeded control information setting requests may be reduced, the load imposed on the controller 40 may correspondingly be reduced.

### EXEMPLARY EMBODIMENT 3

An exemplary embodiment 3 in which, at the time of notification of change of the active host, the controller 40 sets the control information (flow entry) to drop a packed destined to a storage apparatus from a host whose state has been turned from the active state to the standby state, will be explained.

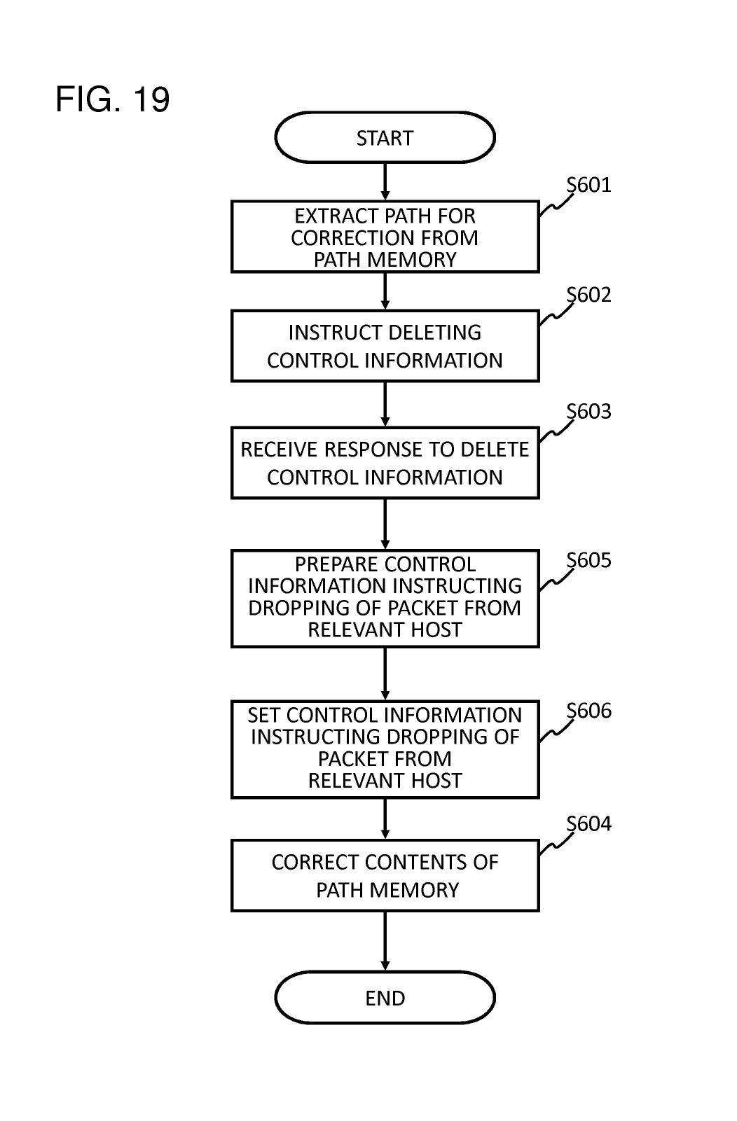

FIG. 19 depicts a flowchart showing the operation of a controller of the exemplary embodiment 3 at the time of receipt of a notification regarding the change of an active host from the access control apparatus. The point of difference in operation of the subject exemplary embodiment 3 from the controller of the exemplary embodiment 1 shown in FIG. 17 is addition of steps S605, S606 between the steps S603 and S604.

On receipt in the step S603 of a response from the switch 30 that the relevant control information (flow entry) has been deleted, the controller 40 prepares the control information (flow entry) to drop the packet originating from the host that has transitioned to the standby state (step S605).

The controller 40 then sets, by its switch control section 44, the above mentioned control information (flow entry) prepared, in the switch 30 connecting to the target host (step S606).

The operations that follow are similar to the exemplary embodiment 1. In the subject exemplary embodiment, it is similarly possible, as in the exemplary embodiment 3, to prevent unneeded packets from flowing in the switch 30 thus possibly resulting in setting requests for unneeded control information. On the other hand, as the number of times of occurrences of the control information setting requests decreases, the load imposed on the controller 40 may be reduced. It is of course possible to combine the exemplary embodiment 2 with the exemplary embodiment 3.

### EXEMPLARY EMBODIMENT 4

An exemplary embodiment 4 will now be explained. In the subject exemplary embodiment, the exemplary embodiment 1 is further modified so that, when the host has turned from the standby state to the active state, at the time of a notification of change of the active host, in the controller 40, path calculations as well as setting of the control information (flow entry) is carried out without waiting for occurrence of communication,

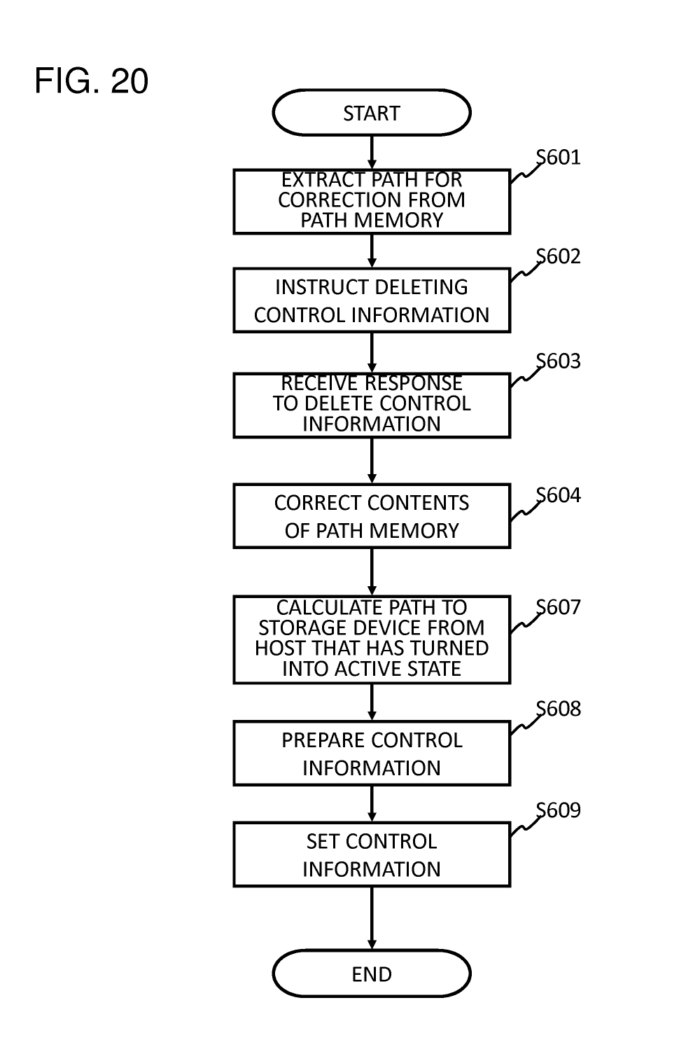

FIG. 20 depicts a flowchart showing the operation of a controller of the exemplary embodiment 4 at the time of a notification from the access control apparatus of the change of an active host. The point of difference in operation of the subject exemplary embodiment from the controller of the exemplary embodiment 1 shown in FIG. 17 is that steps S607 to S609 are added next to the step S604.

If the correction of the content of the path memory 43 has been finished in the step S604, the controller 40 calculates a path to the storage apparatus of the same group from the host that has turned into the active state (step S607).

The controller 40 then prepares, in a step S608, the control information (flow entry) to be set on the switches 30 lying on the path calculated in the step S607.

The controller 40 then sets, by its switch control section 44, the above mentioned control information (flow entry) prepared in the step S608 in the switch 30 (step S609).

In the subject exemplary embodiment, described above, it becomes possible to reduce the response time at the early stage of the accessing as well as to lessen the load on the controller 40 without it being necessary to set a path at the time of the accessing to the storage apparatus from the host that has newly turned into the active state. The subject exemplary embodiment may, of course, be combined with the exemplary embodiment 2, 3 or 4 as desired.

### EXEMPLARY EMBODIMENT 5

The configuration of the exemplary embodiment 1 may be modified to exemplary embodiment 5, 6, which will now be explained. FIG. 21 depicts a block diagram showing a configuration of a storage area network system according to the exemplary embodiment 5. As may be seen from the foregoing explanation on the group-based management of the hosts and the storage apparatuses in the exemplary embodiment 1, a larger number of hosts and a larger number of storage apparatuses are divided into a plurality of groups to manage access control like zoning control, as indicated in FIG. 21.

The number of entries in the access control information memory 52 of the access control apparatus 50, explained in the exemplary embodiment 1, may be dynamically increased or decreased during the operation by newly providing or canceling the groups. The numbers of the hosts or storage apparatuses in the entries may also be dynamically increased or decreased during the operation by adding or canceling a host(s) or a storage apparatus(es) in the entries. In this case, it is only necessary that the access control apparatus 50 notifies the controller 40 of changes in the entries in the access control information memory 52 and that the controller 40 updates the entries in the path memory 43.

### EXEMPLARY EMBODIMENT 6

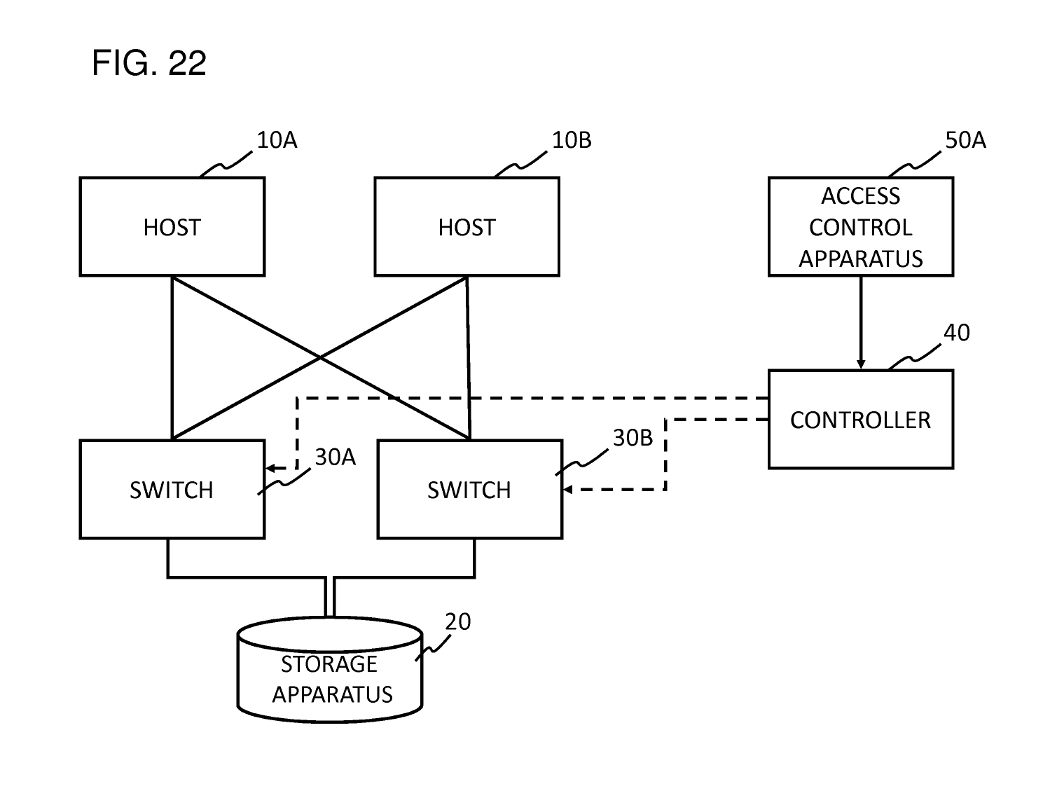

FIG. 22 depicts a block diagram showing a configuration of a storage area network system according to an exemplary embodiment 6. According to the present disclosure, the hosts 10A, 10B and the storage apparatus 20 may be interconnected via a plurality of switches 30A, 30B and multi-path links similar to the configuration of the FP-SAN. Doing so may eliminate single points of failure (SPOF).

In the exemplary embodiment of FIG. 22, the controller 40 as well as the access control apparatus 50 is not multiplexed. However, the controller or the access control apparatus may also be improved as to high availability by relying upon the HA server or the like.

It should be noted that, while preferred exemplary embodiments of the present invention are described above, the present invention is not to be restricted to these particular modes, such that further changes, substitutions or adjustments may be attempted within the range not departing from the basic technical concept of the invention. For example, the configurations of the networks or elements shown in the respective drawings are merely illustrative to assist in understanding of the present invention which is by no means limited to these configurations.

Finally, certain preferred modes of the present invention will be summarized.

### [Mode 1]

See the storage area network system according to the first aspect.

### [Mode 2]

The storage area network system according to mode 1, wherein,
the access control apparatus has therein stored an access control information stating the storage apparatus(es) that can or can not be accessed by the individual hosts, and wherein,
the controller manages access control, using the above mentioned switch, based on the access control information.

### [Mode 3]

The storage area network system according to mode 1 or 2, wherein, the access control apparatus monitors operating states of each host; and wherein,
the controller controls the switch so as to block the access to the storage apparatus(es) from the host in the standby state based on information delivered from the access control apparatus.

### [Mode 4]

The storage area network system according to mode 3, wherein,
when change has occurred in the host that is in an active state or in the host that is in the standby state, the access control apparatus notifies the controller of the content of the change;
the controller controlling the switch so as to prohibit accessing to the storage apparatus(es) from the host(s) that has turned into the standby state and to permit access to the storage apparatus(es) from the host(s) that has turned into the active state.

### [Mode 5]

The storage area network system according to mode 3 or 4, wherein,
on detecting that the host in the active state has failed, the access control apparatus selects one of the hosts that belongs to same group as the failed host; the access control apparatus causing such host to transfer to the active state.

### [Mode 6]

The storage area network system according to mode 5, wherein,
the access control apparatus holds group information donated to the storage apparatus(es), and
controls the hosts so that one host in one group will be in operation in an active state;
the controller controlling the switch so that the host operating in the active state will be able to access the storage apparatus belonging to the own group of the host.

### [Mode 7]

The storage area network system, wherein,
the hosts are a set of computers that access the storage apparatus(s) in response to a request from a client to render services for the client.

### [Mode 8]

See the controller according to the second aspect.

### [Mode 9]

See the access control method according to the third aspect

### [Mode 10]

See the program according to the fourth aspect.

It is noted that, similar to the mode 1, the modes 8 to 10 above can be extended to the modes 2 to 7.

The disclosures of the above mentioned Patent Literatures as well as non-Patent Literatures are to be incorporated herein by reference. A wide variety of combinations or selection of elements herein disclosed (elements of claims, Examples and drawings) may be made within the concept of the claims of the present invention. Viz., the present invention may include a wide variety of changes or corrections that may occur to those skilled in the art in accordance with the total disclosures inclusive of the claims and the drawings as well as the technical concept of the invention. In particular, it should be understood that any optional numerical figures or sub-ranges contained in the ranges of numerical values indicated herein are to be construed to be specifically stated even in the absence of explicit statements.

### INDUSTRIAL APPLICABILITY

From the above description, industrial utilizability of the present invention is explicit. The present invention can preferably be applied to, for example, a data center having a server system of high availability in the form of a plurality of tenants.

### REFERENCE SIGNS LIST

10A-10G hosts
20, 20A-10D storage apparatuses
30, 30A, 30B switches
31 packet processor
32 control information memory
40 controller
41 topology database (topology DB)
42 path calculation section
43 path memory
44 switch control section
45 access control information receiving section
50, 50A access control apparatuses
51 alive/not alive decision section
52 access control information memory

What is claimed is:

1. A storage area network system employing the Ethernet, comprising:
a storage apparatus(es);
a plurality of hosts;
a switch arranged between the storage apparatus(es) and the hosts;
a controller that sets control information in the switch so as to control communication between the hosts and the storage apparatus(es); and
an access control apparatus that provides the controller with information on whether or not accessing between the hosts and the storage apparatus(es) is allowable;
wherein,
the controller sets in the switch the control information corresponding to the information on an access accept/deny that is delivered from the access control apparatus.

2. The storage area network system according to 1, wherein,
the access control apparatus has therein stored an access control information stating the storage apparatus(es) that can or can not be accessed by the individual hosts;
the controller managing access control, using the switch, based on the access control information.

3. The storage area network system according to 1, wherein,
the access control apparatus monitors operating states of each host; and wherein,
the controller controls the switch so as to block the accessing to the storage apparatus(es) from the host in the standby state based on information delivered from the access control apparatus.

4. The storage area network system according to 3, wherein,
when change has occurred in the host that is in an active state or in the host that is in the standby state, the access control apparatus notifies the controller of the content of the change;
the controller controlling the switch so as to prohibit accessing to the storage apparatus(es) from the host(s) that has turned into the standby state and to permit access to the storage apparatus(es) from the host(s) that has turned into the active state.

5. The storage area network system according to 3, wherein,
on detecting that the host in the active state has failed, the access control apparatus selects one of the hosts that belongs to same group as the failed host and that is in the standby state; the access control apparatus causing such host to transfer to the active state.

6. The storage area network system according to claim 1, wherein,
the access control apparatus holds group information donated to the storage apparatus(es), and
controls the hosts so that one host in one group will be in operation in an active state; the controller controlling the switch so that the host operating in the active state will be able to access the storage apparatus belonging to the own group of the host.

7. The storage area network system according to claim 1, wherein,
the hosts are a set of computers that access the storage apparatus(es) in response to a request from a client to render services for the client.

8. A controller, comprising a switch control section that sets control information in a switch arranged between a storage apparatus(es) and a plurality of hosts, together forming a storage area network employing the Ethernet, so as to control communication between the storage apparatus(es) and the hosts, wherein,
the control information that is set by the switch control section corresponds to an access accept/deny delivered from an access control apparatus which provides information on whether or not accessing between the hosts and the storage apparatus(es) is allowable.

9. An access controlling method in a storage area network system employing the Ethernet, comprising a storage apparatus(es), a plurality of hosts, a switch arranged between the storage apparatus(es) and the hosts, a controller that sets control information in the switch so as to control communication between the hosts and the storage apparatus(es), and an access control apparatus that holds information on whether or not accessing between the hosts and the storage apparatus(es) is allowable;
the method comprising
acquiring, from the access control apparatus, the information indicating whether or not accessing between the hosts and the storage apparatus(es) is allowable, and
setting, in the switch, the control information corresponding to the information on an access accept/deny that is delivered from the access control apparatus.

10. A non-transitory computer-readable recording medium storing a program that causes a computer which forms a controller arranged in a storage area network system employing the Ethernet, comprising, in addition to the controller, a storage apparatus(es), a plurality of hosts, a switch arranged between the storage apparatus(es) and the hosts, and an access control apparatus that delivers to the controller information on whether or not accessing between the hosts and the storage apparatus(es) is allowable; the controller setting the control information in the switch to control communication between the hosts and the storage apparatus(es);
to perform processing of acquiring, from the access control apparatus, the information indicating whether or not accessing between the hosts and the storage apparatus(es) is allowable, and
processing of setting, in the switch, the control information corresponding to an access accept/deny that is delivered from the access control apparatus.
